(19) United States
(12) Patent Application Publication
(10) Pub. No.: US 2025/0375038 A1
(43) Pub. Date: Dec. 11, 2025

(54) SEAT CONTROL DEVICE AND SEAT CONTROL METHOD

(71) Applicant: TOYOTA BOSHOKU KABUSHIKI KAISHA, Aichi (JP)

(72) Inventor: Takahiro HARITA, Aichi (JP)

(73) Assignee: TOYOTA BOSHOKU KABUSHIKI KAISHA, Aichi (JP)

(21) Appl. No.: 19/200,039

(22) Filed: May 6, 2025

(30) Foreign Application Priority Data
Jun. 6, 2024 (JP) 2024-092476

(51) Int. Cl. A47C 3/025; B60N 2/00; B60N 2/02

(52) U.S. Cl. CPC A47C 3/0251; B60N 2/0022; B60N 2/02246

(57) ABSTRACT

This invention provides a seat control device with which a passenger can attain a desired sleep induction effect both while a moving body is traveling and while the moving body is stopped. The seat control device includes a rocking device, a determination section, and a control section. If the determination section determines that the moving body is stopped (S3: YES), the control section controls the rocking device so that a rocking speed is set at a first speed. If the determination section determines that the moving body is not stopped (S3: NO), the control section controls the rocking device so that the rocking speed is set at a second speed, which is higher than the first speed.

This Nonprovisional application claims priority under 35 U.S.C. § 119 on Patent Application No. 2024-092476 filed in Japan on Jun. 6, 2024, the entire contents of which are hereby incorporated by reference.

### TECHNICAL FIELD

The present disclosure relates to a seat control device and a seat control method.

### BACKGROUND ART

Conventionally, there have been vehicles and the like each provided with a sleep inducing device which facilitates sleep induction for a passenger. For example, Patent Literature 1 discloses a sleep inducing device according to which, when sleepiness of a passenger of a vehicle is detected, an on-vehicle device such as a seat reclining device is caused to carry out operation suitable to make the passenger fall asleep.

### CITATION LIST

### Patent Literature

### [Patent Literature 1]

Japanese Patent Application Publication, Tokukai, No. 2010-68941

### SUMMARY OF INVENTION

### Technical Problem

Note here that (a) a sleep induction effect for the passenger while the vehicle is traveling and (b) a sleep induction effect for the passenger while the vehicle is stopped differ from each other. Patent Literature 1, however, does not state that the sleep inducing device of Patent Literature 1 changes an operation speed of the seat reclining device so that (a) an operation speed of the seat reclining device while the vehicle is traveling and (b) an operation speed of the seat reclining device while the vehicle is stopped differ from each other.

An aspect of the present disclosure has an object to provide a seat control device and a seat control method with each of which a passenger can attain a desired sleep induction effect both while a moving body is traveling and while the moving body is stopped.

### Solution to Problem

In order to attain the above object, a seat control device in accordance with an aspect of the present disclosure is a seat control device which controls a seat disposed in a moving body, the seat control device including: a rocking device which rocks the seat; a determination section; and a control section which controls operation of the rocking device. The determination section determines whether or not the moving body is stopped. In a case where the determination section determines that the moving body is stopped, the control section controls the rocking device so that a rocking speed, which is a speed for rocking the seat, is set at a first speed. In a case where the determination section determines that the moving body is not stopped, the control section controls the rocking device so that the rocking speed is set at a second speed, which is higher than the first speed.

In order to attain the above object, a seat control method in accordance with an aspect of the present disclosure is a seat control method for controlling a seat disposed in a moving body, the seat control including: a determination step of determining whether or not the moving body is stopped; and a control step of controlling operation of a rocking device which rocks the seat. In a case where the determination step determines that the moving body is stopped, the control step controls the rocking device so that a rocking speed, which is a speed for rocking the seat, is set at a first speed. In a case where the determination step determines that the moving body is not stopped, the control step controls the rocking device so that the rocking speed is set at a second speed, which is higher than the first speed.

### Advantageous Effects of Invention

In accordance with an aspect of the present disclosure, a passenger can attain a desired sleep induction effect both while a moving body is traveling and while the moving body is stopped.

### BRIEF DESCRIPTION OF DRAWINGS

FIG. 1 is a block diagram illustrating a configuration of a seat control device in accordance with a first embodiment of the present disclosure.

FIG. 2 is a view illustrating an external appearance of one example of an overall configuration of the seat control device in accordance with the first embodiment.

FIG. 3 is a view illustrating one example of a frame of a seat in accordance with the first embodiment.

FIG. 4 is a view illustrating one example of rocking operation of a rocking device in accordance with the first embodiment.

FIG. 5 is a flowchart illustrating one example of a flow of a control process for the rocking device which control process is carried out by the seat control device in accordance with the first embodiment.

FIG. 6 is a view illustrating one example of (i) a result of a sensory analysis carried out while a vehicle was traveling and (ii) a result of a sensory analysis carried out while the vehicle was stopped.

FIG. 7 is a view illustrating one example of a measurement result of a time taken for a passenger to fall asleep while a vehicle was stopped.

FIG. 8 is a view illustrating one example of a measurement result of a time taken for a passenger to fall sleep while a vehicle was traveling.

FIG. 9 is a flowchart illustrating one example of a flow of a control process for a rocking device which control process is carried out by a seat control device in accordance with a second embodiment of the present disclosure.

### DESCRIPTION OF EMBODIMENTS

### First Embodiment

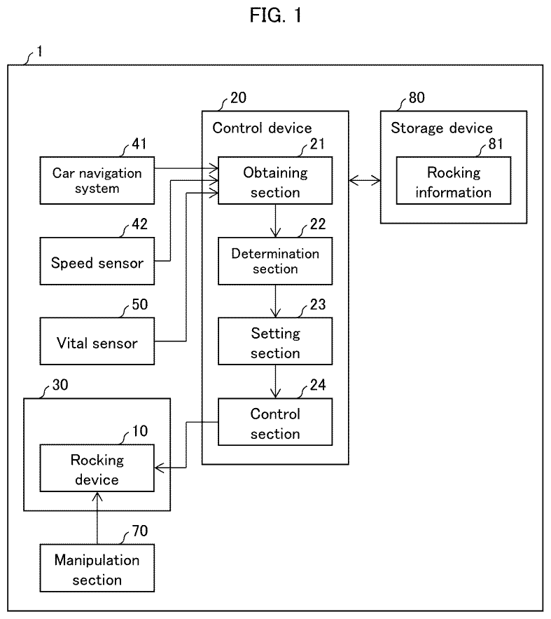

The following description will discuss, with reference to FIGS. 1 to 8, a seat control device 1 in accordance with a first embodiment of the present disclosure.

### Configuration of Seat Control Device

FIG. 1 is a block diagram illustrating a configuration of the seat control device 1 in accordance with the first embodiment. As shown in FIG. 1, the seat control device 1 includes a control device 20, a seat 30, a car navigation system 41, a speed sensor 42, a manipulation section 70, and a storage device 80.

The seat control device 1 is provided to a vehicle, for example. The vehicle is one example of a moving body. Note that the subject to which the seat control device 1 is provided is not limited to the vehicle. Alternatively, the seat control device 1 may be provided to an air craft, a train, a ship, or the like.

The control device 20 includes an obtaining section 21, a determination section 22, a setting section 23, and a control section 24. The obtaining section 21 is electrically connected to the car navigation system 41, the speed sensor 42, and a vital sensor 50.

The seat 30 is a seating place provided in an interior space of the vehicle. The seat 30 includes a rocking device 10. The rocking device 10 is a device which rocks the seat 30. The rocking device 10 is a device which rocks the seat 30 so as to relax a passenger sitting on the seat 30 and to stimulate the otoliths involved in passenger's sense of equilibrium, thereby giving a sleep induction effect to the passenger.

The car navigation system 41 is a car navigation device mounted on the vehicle. The car navigation system 41 stores, for example, map data therein. While the vehicle is traveling, the car navigation system 41 obtains information of a current position by a Global Positioning System (GPS), and makes route guidance with voice and on-screen indication of a route from the current position to a destination. The car navigation system 41 transmits, to the obtaining section 21, positional information as to the current position of the vehicle.

The speed sensor 42 detects a speed of the vehicle. The speed sensor 42 transmits, to the obtaining section 21, a speed signal corresponding to the detected speed of the vehicle.

The vital sensor 50 is a sensor which is disposed in the interior space of the vehicle and which obtains biological information of a passenger staying in the interior space of the vehicle. The biological information includes, for example, a heart rate of the passenger, an electroencephalogram of the passenger, a captured image of at least a part of the passenger's body, and/or the like. The vital sensor 50 transmits, to the obtaining section 21, the detected biological information of the passenger.

The obtaining section 21 obtains the positional information from the car navigation system 41, the speed signal from the speed sensor 42, and the biological information from the vital sensor 50 at predetermined time intervals.

The determination section 22 determines, on the basis of the speed signal from the speed sensor 42, whether or not the vehicle is stopped. On the basis of the biological information from the vital sensor 50, the determination section 22 may determine whether or not the passenger is sleeping or may identify the passenger. The determination section 22 outputs a result of the determination to the setting section 23.

The setting section 23 sets a rocking speed and a rocking period. The rocking speed is a speed at which the rocking device 10 rocks the seat 30. The rocking period is a period for which the rocking device 10 rocks the seat 30. To be more specific, the setting section 23 sets the rocking speed and the rocking period by referring to the result of the determination made by the determination section 22 and rocking information 81 stored in the storage device 80. Each of the rocking speed and the rocking period has respective different values for a traveling mode and a stopped mode (described later).

The control section 24 controls operation of the rocking device 10. To be more specific, the control section 24 causes the rocking device 10 to operate with the rocking speed and the rocking period each having been set by the setting section 23.

The manipulation section 70 accepts various kinds of manipulations carried out by the passenger. For example, the manipulation section 70 accepts a manipulation for starting or stopping the rocking device 10. The manipulation section 70 also accepts a manipulation for setting a rocking period of the rocking device 10.

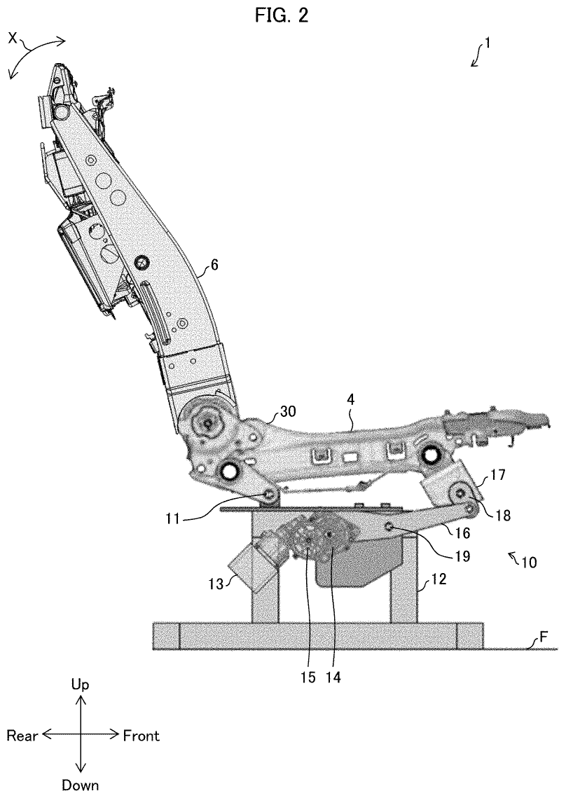

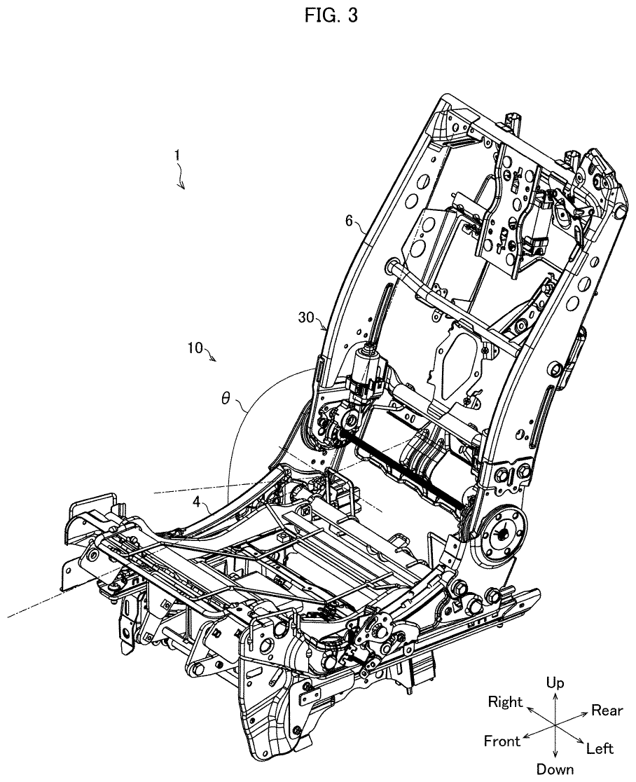

FIG. 2 is a view illustrating an external appearance of one example of an overall configuration of the seat control device 1 in accordance with the first embodiment. FIG. 3 is a view illustrating one example of a frame of the seat 30 in accordance with the first embodiment. In the following description, for convenience of explanation, an up-down direction, a front-rear direction, and a left-right direction of the seat control device 1 are defined as indicated by the arrows illustrated in FIGS. 2 and 3.

As shown in FIG. 2, the seat control device 1 includes the seat 30 and the rocking device 10. The seat control device 1 is applied to, for example, seats 30 of respective seating places provided to the vehicle. The seat 30 is a support member which supports the passenger's body.

Note that the seating places include a driver seat, a front passenger seat, and a rear seat(s) of the vehicle. Note also that each seat 30 includes a bed, a sofa, or any of other members which is equivalent to them and which allows a passenger to sit thereon.

The rocking device 10 includes a first fulcrum 11, a base 12, a motor 13, a sector gear 14, a pinion gear 15, a first plate 16, a second plate 17, a bracket 18, and a second fulcrum 19, for example.

The rocking device 10 is a device which rocks the seat 30 about the first fulcrum 11 in a pitching direction X on the base 12. The base 12 is fixed to a floor surface F. To the base 12, the motor 13 and a plurality of gears including the sector gear 14 are attached.

The control section 24 rotates a rotation shaft of the motor 13 in a forward direction and a reverse direction, so as to rock the seat 30 in the front-rear direction via the pinion gear 15 attached to the rotation shaft. To be more specific, power of the pinion gear 15 is transmitted to the sector gear 14, and then is applied to a lower part of the seat 30 through the first plate 16 to which the sector gear 14 is fixed, the second plate 17, and the bracket 18.

During this, an angle between the first plate 16 and the second plate 17 and an angle between the second plate 17 and the bracket 18 are variable. The first plate 16 turns about the second fulcrum 19 in a certain range. That is, when a front part of the first plate 16 is positioned upward, a rear part of the first plate 16 is positioned downward. Meanwhile, when the rear part of the first plate 16 is positioned upward, the front part of the first plate 16 is positioned downward. That is, when the sector gear 14 turns, the front part of the first plate 16 moves up and down. This causes repeated reciprocating motions of the seat 30 about the first fulcrum 11.

As shown in FIG. 3, the seat 30 includes a seating part 4 and a back part 6. The seat 30 is configured such that an angle θ between the seating part 4 and the back part 6 can be adjusted by a reclining function.

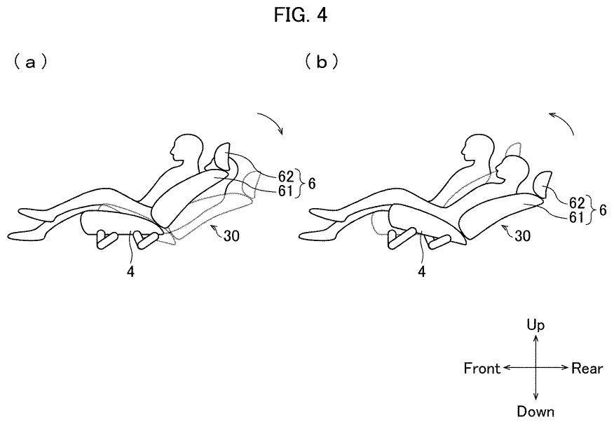

FIG. 4 is a view illustrating one example of rocking operation of the rocking device 10 in accordance with the first embodiment. Rocking of the seat 30 refers to reciprocating motions in which rearward tilting of the seat 30 as illustrated in (a) of FIG. 4 and forward movement of the seat 30 as illustrated in (b) of FIG. 4 are alternately carried out repeatedly. It is desirable that rocking of the seat 30 be carried out with an angle between the seating part 4 and the back part 6 being constant. The back part 6 of the seat 30 may include a seatback 61 and a headrest 62.

### [Flow of Control Process for Rocking Device by Seat Control Device]

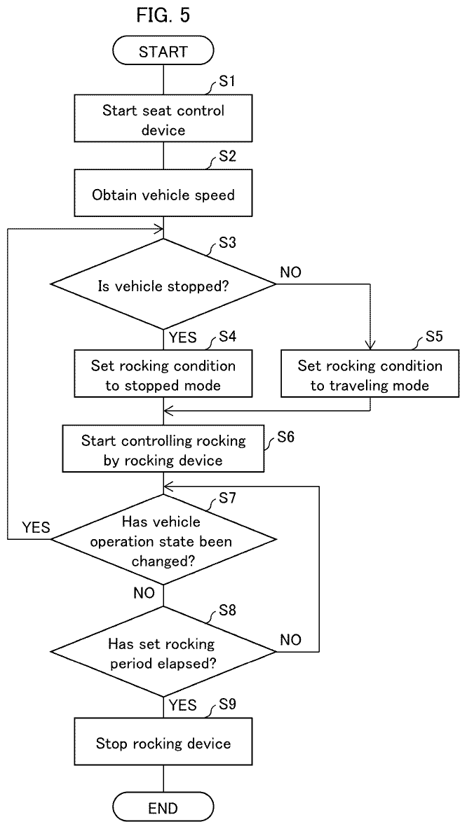

FIG. 5 is a flowchart illustrating one example of a flow of a control process for the rocking device 10 which control process is carried out by the seat control device 1 in accordance with the first embodiment. In the flowchart shown in FIG. 5, when a passenger carries out a manipulation for turning on with respect to the manipulation section 70, the seat control device 1 is started (S1). Note that the seat control device 1 may be started at the same time as starting of the engine.

After step S1, the obtaining section 21 of the control device 20 obtains a speed of the vehicle from the speed sensor 42 (S2). Then, the obtaining section 21 transmits the obtained speed of the vehicle to the determination section 22.

The determination section 22 determines, at predetermined time intervals, whether or not the vehicle is stopped (S3: determination step). For example, the “predetermined time” is 18 to 20 seconds while the vehicle is stopped, and the “predetermined time” is 14 to 16 seconds while the vehicle is traveling. By carrying out the determination in step S3 at predetermined time intervals in this manner, it is possible to prevent a phenomenon that the rocking speed of the rocking device 10 frequently changes and the passenger feels uncomfortable.

In step S3, the determination section 22 determines that the vehicle is stopped when the speed of the vehicle is 0 km/h for a certain period or more. For example, the “certain period” is 50 to 140 seconds. In a case where the gear is at a “P position” or the positional information of the vehicle which positional information has been obtained by the car navigation system 41 indicates that the vehicle is in a parking space, the determination section 22 may determine that the vehicle is stopped.

If the determination section 22 determines that the vehicle is stopped (S3: YES), the setting section 23 sets a rocking condition to the “stopped mode” (S4). Meanwhile, if the determination section 22 determines that the vehicle is not stopped, that is, the vehicle is traveling (S3: NO), the setting section 23 sets the rocking condition to the “traveling mode” (S5).

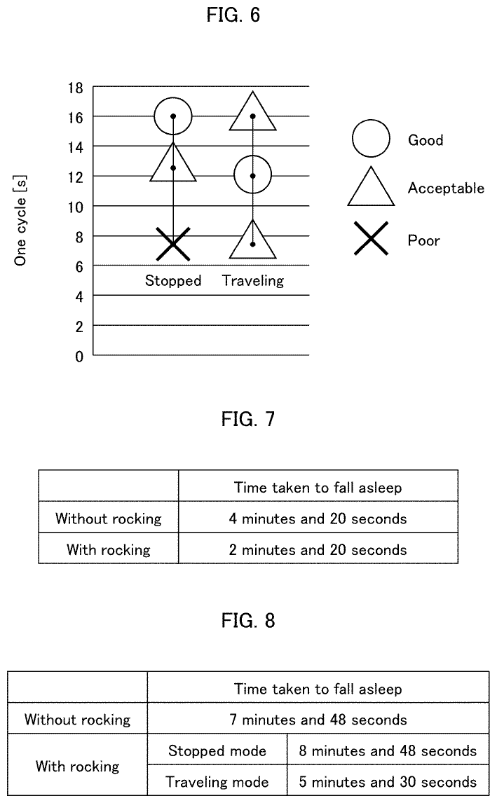

Next, the following description will discuss the “stopped mode” and the “traveling mode”. FIG. 6 is a view illustrating one example of (i) a measurement result of a sensory analysis carried out while the vehicle was traveling and (ii) a measurement result of a sensory analysis carried out while the vehicle was stopped. As shown in FIG. 6, it is shown that, while the vehicle is stopped, rocking the seat 30 by the rocking device 10 for approximately 16 seconds per cycle gives a good sleep induction effect.

It is also shown that, while the vehicle is traveling, rocking the seat 30 by the rocking device 10 in cycles of approximately 12 seconds gives a good sleep induction effect. That is, while the vehicle is traveling, rocking the seat 30 at a higher rocking speed than the rocking speed employed while the vehicle is stopped can easily make a passenger fall asleep.

FIG. 7 is a view illustrating one example of a measurement result of a time taken for the passenger to fall asleep while the vehicle was stopped. As shown in FIG. 7, while the vehicle was stopped, not rocking the seat 30 took “4 minutes and 20 seconds” for the passenger to fall asleep. On the other hand, while the vehicle was stopped, rocking the seat 30 in the “stopped mode” took “2 minutes and 20 seconds” for the passenger to fall asleep. That is, it was confirmed that, while the vehicle was stopped, rocking the seat 30 in the “stopped mode” took a shorter time for the passenger to fall asleep than when the seat 30 was not rocked.

FIG. 8 is a view illustrating one example of a measurement result of a time taken for the passenger to fall sleep while the vehicle was traveling. While the vehicle was traveling on a paved road at a speed of 30 km to 70 km per hour, not rocking the seat 30 took “7 minutes and 48 seconds” for the passenger to fall asleep, as shown in FIG. 8. On the other hand, while the vehicle was traveling, rocking the seat 30 in the “traveling mode” took “5 minutes and 30 seconds” for the passenger to fall asleep. That is, it was confirmed that, while the vehicle was traveling, rocking the seat 30 in the “traveling mode” took a shorter time for the passenger to fall asleep than when the seat 30 was not rocked.

Note that, while the vehicle was traveling, rocking the seat 30 in the “stopped mode” took “8 minutes and 48 seconds” for the passenger to fall asleep. That is, this took a longer time for the passenger to fall asleep than when the seat 30 was not rocked. That is, it was confirmed that, while the vehicle was traveling, rocking the seat 30 in the “stopped mode” could not yield a desired sleep induction effect.

In view of the measurement results shown in FIGS. 6 to 8, the setting section 23 sets a second speed, which is a rocking speed in the “traveling mode”, so as to be 1.3 times higher than a first speed, which is a rocking speed in the “stopped mode”. It is preferable that the second speed be equal to or lower than a speed twice the first speed.

Note that a rocking period in the “stopped mode” and a rocking period in the “traveling mode” are set so as to be almost equal to each other. To be more specific, each of the rocking period in the “traveling mode” and the rocking period in the “stopped mode” is approximately 20 minutes.

Referring back to FIG. 5, after step S4 or step S5, the control section 24 starts controlling rocking by the rocking device 10 under the rocking condition having been set by the setting section 23 (S6: control step).

After step S6, the determination section 22 determines whether or not an operation state of the vehicle has been changed (S7). To be more specific, the determination section 22 determines, on the basis of the speed of the vehicle obtained by the obtaining section 21, whether the operation state of the vehicle has been changed from a traveling state to a stopped state or the operation state of the vehicle has been changed from the stopped state to the traveling state.

If the operation state of the vehicle has been changed (S7: YES), that is, if the operation state of the vehicle has been changed from the traveling state to the stopped state or if the operation state of the vehicle has been changed from the stopped state to the traveling state, the process returns to step S3 and the determination section 22 determines whether or not the vehicle is stopped.

Then, after the setting section 23 changes the rocking condition to the stopped mode or the traveling mode, the control section 24 restarts rocking of the rocking device 10 in the changed operation mode. In this process, at a timing that a direction of the seat 30 is reversed, that is, at a timing that forward tilting of the seat 30 is changed to rearward tilting of the seat 30 or at a timing that rearward tilting of the seat 30 is changed to forward tilting of the seat 30, the control section 24 controls the rocking device 10 to change the rocking speed of the seat 30.

Meanwhile, if the operation state of the vehicle has not been changed (S7: NO), that is, if the vehicle keeps traveling or if the vehicle keeps stopped, the determination section 22 determines whether or not the rocking period having been set by the setting section 23 has elapsed (S8).

Until elapse of the rocking period having been set (S8: NO), the control section 24 repeatedly carries out step S7. Meanwhile, if the rocking period having been set has elapsed (S8: YES), the control section 24 stops the rocking device 10 (S9). Consequently, the control process for the rocking device 10 which control process is carried out by the seat control device 1 shown in FIG. 5 is ended.

With the above-described seat control device 1 in accordance with the first embodiment, the control section 24 causes the rocking device 10 to carry out rocking at a higher rocking speed while the vehicle is traveling, that is, while the vehicle is running than while the vehicle is stopped. Consequently, it is possible to give a desired sleep induction effect to the passenger who is supported by the seat 30 both while the vehicle is stopped and while the vehicle is traveling.

Further, with the above-described seat control device 1, changing of the rocking speed while the seat 30 is rocking is carried out in the following manner. That is, at a timing that a direction of the seat 30 is reversed, the control section 24 controls the rocking device 10 to change the rocking speed of the seat 30. This makes it possible to prevent a phenomenon that the rocking speed of the seat 30 changes while the seat 30 is being tilted forward or while the seat 30 is being tilted rearward. Consequently, it is possible to change the rocking speed of the seat 30 without giving an uncomfortable feeling to the passenger.

Furthermore, the determination section 22 determines, at predetermined time intervals, whether the vehicle is stopped or the vehicle is traveling (S3). This makes it possible to prevent a phenomenon that, while the vehicle is traveling in, e.g., a town or the like with many traffic signals, the rocking speed of the seat 30 changes every time the vehicle stops. Consequently, it is possible to change the rocking speed of the seat 30 without giving an uncomfortable feeling to the passenger.

Moreover, since the seat control device 1 is started (S1) by the passenger manipulating the manipulation section 70, it is possible to determine, according to the passenger's intention, whether to carry out rocking of the seat 30 by the seat control device 1. Consequently, it is possible to prevent the passenger from rocking the seat 30 against his/her will.

### Second Embodiment

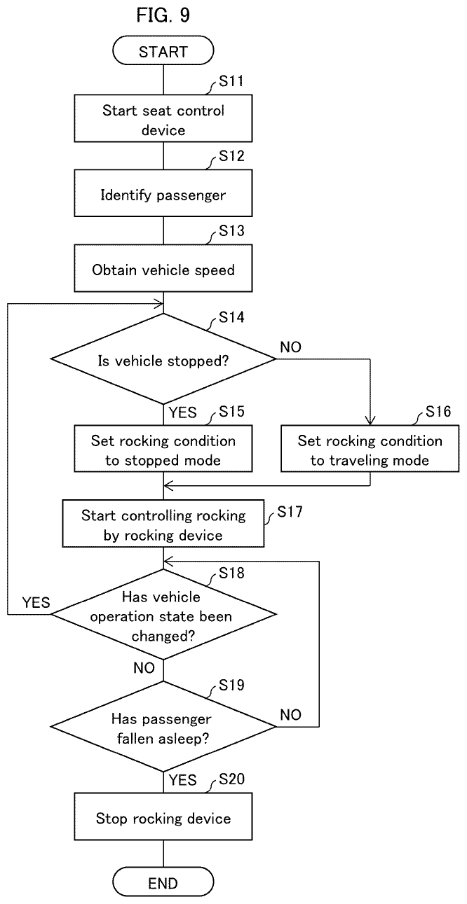

Next, the following description will discuss, with reference to FIG. 9, a seat control device 1 in accordance with a second embodiment of the present disclosure. For convenience of description, a member having a function identical to that of a member discussed in the first embodiment is given an identical reference sign, and a description thereof is omitted.

A flow of a control process for a rocking device 10 which control process is carried out by a control section 24 of a seat control device 1 in accordance with the second embodiment differs from that of the first embodiment. FIG. 9 is a flowchart illustrating one example of a flow of the control process for the rocking device 10 which control process is carried out by the control device 24 of the seat control device 1 in accordance with the second embodiment. In the flowchart shown in FIG. 9, when a passenger carries out a manipulation for turning on with respect to a manipulation section 70, the seat control device 1 is started (S11).

After step S11, a determination section 22 identifies the passenger by using biological information and/or the like obtained by a vital sensor 50 (S12). The determination section 22 is one example of an identifying section which identifies a passenger of a vehicle.

In S12, the determination section 22 can identify a passenger on the basis of capturing an image of the passenger's face by using the vital sensor 50 as a camera, for example. Note that the determination section 22 may identify the passenger on the basis of obtaining, by the obtaining section 21 via a communication section (not illustrated), information from a communication device carried by the passenger.

After step S12, the obtaining section 21 obtains a speed of the vehicle from the speed sensor 42 (S13), and transmits the obtained speed of the vehicle to the determination section 22. The determination section 22 determines, at predetermined time intervals, whether or not the vehicle is stopped (S14).

If the determination section 22 determines that the vehicle is stopped (S14: YES), the setting section 23 sets a rocking condition to a “stopped mode” (S15). During this, the setting section 23 refers to rocking information 81 in a storage device 80, and sets a rocking speed optimum for each passenger, the rocking speed being suitable for the passenger identified in step S12. Assume that, in the storage device 80, information as to sleep induction characteristics indicative of a relation between a rocking speed of a seat 30 and easiness for each passenger to fall asleep is stored as the rocking information 81 in advance. Note that the setting section 23 may set a rocking period suitable for the passenger.

Meanwhile, if the determination section 22 determines that the vehicle is not stopped, that is, the vehicle is traveling (S14: NO), the setting section 23 sets the rocking condition to a “traveling mode” (S16). Also during this, the setting section 23 refers to the rocking information 81 in the storage device 80, and sets a rocking speed suitable for the passenger having been identified in step S12. A rocking speed in the “traveling mode” is set so as to be approximately 1.3 times higher than a rocking speed in the “stopped mode”.

After step S15 or step S16, the control section 24 starts controlling rocking of the seat 30 by the rocking device 10 under the rocking condition having been set by the setting section 23 (S17).

After step S17, the determination section 22 determines whether or not an operation state of the vehicle has been changed (S18). If the operation state of the vehicle has been changed (S18: YES), the process returns to step S14, and the determination section 22 determines whether or not the vehicle is stopped.

Meanwhile, if the operation state of the vehicle has not been changed (S18: NO), the determination section 22 determines, on the basis of the biological information obtained by the vital sensor 50, whether or not the passenger has fallen asleep while the rocking device 10 is operating (S19).

In S19, the determination section 22 may determine whether or not the passenger has fallen asleep, by using, as the vital sensor 50, a sensor which detects an electroencephalogram or a heart rate. To be more specific, the determination section 22 may determine whether or not the passenger has fallen asleep in such a manner that the determination section 22 detects, by using a wireless electroencephalograph as the vital sensor 50, a particular electroencephalogram appearing when a person falls asleep. Further, the determination section 22 may determine whether or not the passenger has fallen asleep, on the basis of detection of changes in heart rate which detection is carried out by using a heart rate sensor as the vital sensor 50.

The control section 24 carries out step S18 repeatedly until the determination section 22 determines that the passenger has fallen asleep (S19: NO). Meanwhile, if the determination section 22 determines that the passenger has fallen asleep (YES), the control section 24 stops the rocking device (S20). Consequently, the control process for the rocking device 10 which control process is carried out by the seat control device 1 shown in FIG. 9 is ended.

Also with the above-described seat control device 1 in accordance with the second embodiment, it is possible to attain similar effects to those of the first embodiment. In particular, with the seat control device 1 in accordance with the second embodiment, after the determination section 22 determines that the passenger has fallen asleep (S19: YES), the control section 24 stops the rocking device 10. Consequently, it is possible to prevent the rocking device 10 from continuing operating unnecessarily, thereby making it possible to reduce unnecessary power consumption.

In addition, in step S15 or step S16, the setting section 23 individually sets, in consideration of sleep induction characteristics of each passenger, a rocking speed for rocking the seat 30, and then the control section 24 causes the rocking device 10 to carry out operation with the rocking device optimum for each passenger. Consequently, it is possible to further enhance the sleep induction effect for each passenger which sleep induction effect is attained by rocking the seat 30.

### OTHER EMBODIMENTS

In the above-described first and second embodiments, the determination section 22 of the control device 20 determines, at predetermined time intervals, whether or not the vehicle is stopped (S3). However, this is not limitative. Alternatively, once the rocking device 10 starts rocking, the rocking speed may not be changed until the seat 30 finishes a predetermined number of times of reciprocating movement. Consequently, it is possible to change the rocking speed of the seat 30 without preventing or reducing a situation in which the rocking speed of the seat 30 suddenly changes and accordingly the passenger feels uncomfortable.

Further, in the above-described first embodiment, if the rocking period set by the setting section 23 has elapsed (S8: YES), the control section 24 stops the rocking device 10. However, this is not limitative. Alternatively, the rocking device 10 may be stopped according to the passenger manipulating the manipulation section 70. Further, the setting for the rocking period of the rocking device 10 may be changed according to the passenger manipulating the manipulation section 70.

In the above-described first and second embodiments, the seat control device 1 rocks the seat 30 in the front-rear direction as shown in FIG. 4. However, this is not limitative. Alternatively, for example, the seat 30 may be rocked in the left-right direction.

### Software Implementation Example

Functions of the seat control device 1 (hereinafter referred to as a “device”) can be realized by a program for causing a computer to function as the device, the program causing the computer to function as control blocks (the obtaining section 21, the determination section 22, the setting section 23, and the control section 24) of the device.

In this case, the device includes a computer that has at least one control device (for example, a processor) and at least one storage device (for example, a memory) as hardware for executing the program. The control device and the storage device execute the program, so that the functions described in the above embodiments are realized.

The program can be stored in one or more non-transitory computer-readable storage media. The storage medium can be provided in the device, or the storage medium does not need to be provided in the device. In the latter case, the program can be supplied to the device via any wired or wireless transmission medium.

A part or all of the functions of the control blocks can be realized by a logic circuit. For example, an integrated circuit in which a logic circuit that functions as each of the control blocks is formed is also encompassed in the scope of the present disclosure. In addition, the function of each of the control blocks can be realized by, for example, a quantum computer.

Further, each of the processes described in the above embodiments can be executed by artificial intelligence (AI). In this case, the AI may be operated by the control device or may be operated by another device (for example, an edge computer and a cloud server).

The present disclosure is not limited to the above embodiments, but can be altered by a person skilled in the art within the scope of the claims. The present disclosure also encompasses, in its technical scope, any embodiment derived by combining technical means disclosed in the embodiments.

### REFERENCE SIGNS LIST

1: seat control device
10: rocking device
20: control device
21: obtaining section
22: determination section
23: setting section
24: control section
30: seat
41: car navigation system
42: speed sensor
50: vital sensor
70: manipulation section
80: storage device

1. A seat control device which controls a seat disposed in a moving body, the seat control device comprising:
a rocking device which rocks the seat;
a determination section; and
a control section which controls operation of the rocking device,
the determination section determining whether or not the moving body is stopped,
in a case where the determination section determines that the moving body is stopped, the control section controlling the rocking device so that a rocking speed, which is a speed for rocking the seat, is set at a first speed, and
in a case where the determination section determines that the moving body is not stopped, the control section controlling the rocking device so that the rocking speed is set at a second speed, which is higher than the first speed.

2. The seat control device according to claim 1, wherein:
at a timing that a direction of the rocking of the seat is reversed, the control section changes the rocking speed.

3. The seat control device according to claim 1, wherein:
the determination section determines, at predetermined time intervals, whether or not the moving body is stopped.

4. The seat control device according to claim 1, further comprising:
a manipulation section which accepts various kinds of manipulations carried out by a passenger, wherein:
in a case where the manipulation section accepts a given manipulation carried out by the passenger, the seat control device is started or stopped.

5. The seat control device according to claim 1, further comprising:
a vital sensor which obtains biological information of a passenger of the moving body, wherein:
the determination section determines, on a basis of the biological information obtained by the vital sensor, whether or not the passenger is sleeping;
while the rocking device is operating, the control section operates such that (a) in a case where the determination section determines that the passenger is sleeping, the control section stops the rocking device and (b) in a case where the determination section does not determine that the passenger is sleeping, the control section does not stop the rocking device.

6. The seat control device according to claim 1, further comprising:
an identifying section which identifies a passenger of the moving body; and
a setting section which sets a rocking speed and a rocking period each suitable for the passenger identified by the identifying section, the rocking period being a period for rocking the seat, wherein:
the control section causes the rocking device to carry out rocking with the rocking speed and the rocking period having been set by the setting section.

7. A seat control method for controlling a seat disposed in a moving body, the seat control method comprising:
a determination step of determining whether or not the moving body is stopped; and
a control step of controlling operation of a rocking device which rocks the seat,
in a case where the determination step determines that the moving body is stopped, the control step controlling the rocking device so that a rocking speed, which is a speed for rocking the seat, is set at a first speed, and
in a case where the determination step determines that the moving body is not stopped, the control step controlling the rocking device so that the rocking speed is set at a second speed, which is higher than the first speed.
